(19) United States
(12) Patent Application Publication
(10) Pub. No.: US 2020/0166610 A1
(43) Pub. Date: May 28, 2020

(54) DETECTION METHOD, DETECTION DEVICE, TERMINAL AND DETECTION SYSTEM

(71) Applicant: JOMOO KITCHEN & BATH CO., LTD, Nan'an City (CN)

(72) Inventors: Xiaofa LIN, Nan'an City (CN); Xiaoshan LIN, Nan'an City (CN); Jinyu HU, Nan'an City (CN)

(73) Assignee: JOMOO KITCHEN & BATH CO., LTD, Nan'an City (CN)

(21) Appl. No.: 16/590,577

(22) Filed: Oct. 2, 2019

(30) Foreign Application Priority Data
Nov. 22, 2018 (CN) 201811400984.7

(51) Int. Cl. G01S 7/41; G01S 7/292; G01S 7/295

(52) U.S. Cl. CPC G01S 7/415; G01S 7/295; G01S 7/2921

(57) ABSTRACT

A detection method, a detection device, a terminal, and a detection system are provided, for detecting a state of a target object in a detection area. The detection method includes: filtering a millimeter-wave radar signal received in the detection area; and extracting features suitable for indicating a motion mode of the target object in the detection area from each frame of the filtered millimeter-wave radar signal; monitoring an initial change point of the features through a flow window; caching a predetermined number of features starting from the initial change point; and identifying the cached features by a classifier to determine the state of the target object in the detection area.

### CROSS-REFERENCE TO RELATED APPLICATION

This application claims foreign priority benefits under 35 U.S.C. § 119(a)-(d) to Chinese patent application number CN 201811400984.7 filed Nov. 22, 2018, which is incorporated by reference in its entirety.

### TECHNICAL FIELD

The present application relates to, but not limited to, the computer technology field, and particularly to a detection method, a detection device, a terminal, and a detection system.

### BACKGROUND

With the development of computer technology, in more and more scenarios, sensors are used to detect states of a human body. For example, solutions based on sensors for detecting whether a human body falls may be divided into a wearable solution, a contact solution, and a contactless solution. In the wearable solution, a user need to wear some device (for example, a motion sensor) all the time, which leads to inconvenience of the user and limits the usage in some scenarios (for example, a bath scenario). In the contact solution, sensors, such as switches, pressure and vibration sensors, need to be installed near the surface (such as mat, floor, etc.) involved in the impact of a fall of a user. In this solution, the detection accuracy depends on the number and installation location of the sensors. In order to improve the detection accuracy, it may be needed to modify or redesign the detection environment (for example, the indoor environment for family), which results in a high reconstruction cost. In the contactless solution, a camera (such as a 3D depth camera) is usually used to collect video images, and whether a human body falls is determined according to the collected video images. In this solution, video image collection and detection through the camera are not only greatly affected by the environment, but also violate user privacy to some extent (especially in private environments such as a bathroom).

### SUMMARY

The following is an overview of the subject matter detailed in this disclosure. The overview is not intended to limit the protection scope of the claims.

Embodiments of this application provide a detection method, a detection device, a terminal, and a detection system, by which a better detection effect may be ensured on the basis of protecting user privacy.

In one aspect, an embodiment of this application provides a detection method for detecting a state of a target object in a detection area. The detection method includes: filtering a millimeter-wave radar signal received in the detection area; extracting features suitable for indicating a motion mode of the target object in the detection area from each frame of the filtered millimeter-wave radar signal; monitoring an initial change point of the features through a flow window; caching a predetermined number of features starting from the initial change point; and identifying the cached features by a classifier to determine the state of the target object in the detection area.

In another aspect, an embodiment of the present application provides a detection device for detecting a state of a target object in a detection area. The detecting device includes: a filter module, adapted to filter a millimeter-wave radar signal received in the detection area; a feature extraction module, adapted to extract features suitable for indicating a motion mode of the target object in the detection area from each frame of the filtered millimeter-wave radar signal; a monitoring module, adapted to monitor an initial change point of the features through a flow window; a cache module, adapted to cache a predetermined number of features starting from the initial change point; a classifier, adapted to identify the cached features to determine the state of the target object within the detection area.

In yet another aspect, an embodiment of this application provides a terminal including a memory and a processor, the memory is adapted to store a detection program, which, when executed by the processor, cause the processor to implement the above detection method.

In still another aspect, an embodiment of this application provides a detection system for detecting a state of a target object in a detection area. The detection system includes: an ultra-wideband radar sensor and a data processing terminal. The ultra-wideband radar sensor is adapted to transmit a millimeter-wave radar signal and receive a returned millimeter-wave radar signal within the detection area. The data processing terminal is adapted to obtain the received millimeter-wave radar signal from the ultra-wideband radar sensor and filter the received millimeter-wave radar signal; extract features suitable for indicating a motion mode of the target object in the detection area from each frame of the filtered millimeter-wave radar signal; monitor an initial change point of the features through a flow window, and cache a predetermined number of features starting from the initial change point; identify the cached features by a classifier to determine the state of the target object in the detection area.

In still another aspect, an embodiment of this application provides a computer readable medium in which a detection program is stored for implementing steps of the above detection method when the detection program is executed by a processor.

In embodiments of this application, a state detection is performed based on a millimeter-wave radar signal, which can protect the user privacy, and is especially suitable for the state detection in a private environment such as a bathroom. A detection effect may be ensured by extracting the features suitable for indicating the motion mode of the target object in the detection area from the millimeter-wave radar signal for state identification. Embodiments of this application ensure good detection effect on the basis of protecting the user privacy, which is not only convenient to implement, but also suitable for various environments.

After reading and understanding the drawings and detailed description, other aspects may be understood.

### BRIEF DESCRIPTION OF THE DRAWINGS

The accompanying drawings are used to provide a further understanding of the technical solution of the application and constitute a part of the specification. The accompanying drawings are used together with the embodiments of the application to explain the technical solution of the application, but do not constitute a limitation on the technical solution of the application.

FIG. 1 is a flowchart of a detection method provided by an embodiment of the application.

FIG. 2 is a schematic diagram of an application scenario of the detection method provided by an embodiment of the application.

FIG. 3 is a schematic diagram of a detection device provided by an embodiment of this application.

FIG. 4 is a schematic diagram of an application example provided by an embodiment of this application.

FIG. 5 is a schematic diagram of FEAT indicating a motion mode of a target object within a detection area in the above application example.

FIG. 6 shows an example of FEAT in the above application example.

FIG. 7 is a schematic diagram of a terminal provided by an embodiment of this application.

FIG. 8 is a schematic diagram of a detection system provided by an embodiment of this application.

### DETAILED DESCRIPTION

Embodiments of this application are to be described in details below in conjunction with the accompanying drawings. It should be noted that, without conflict, the embodiments in this application and the features in the embodiments may be arbitrarily combined with each other.

Steps illustrated in the flowchart in the drawings may be performed in a computer system such as a set of computer-executable instructions. Also, although the logical order is shown in the flowchart, in some cases the steps shown or described may be performed in an order different from here.

Embodiments of this application provide a detection method, a detection device, a terminal, and a detection system for detecting a state of a target object in a detection area. Target objects may include movable objects such as a human body, an animal body, etc. Detection areas may include indoor environments such as a bedroom, a bathroom, etc. However, this application is not limited to these.

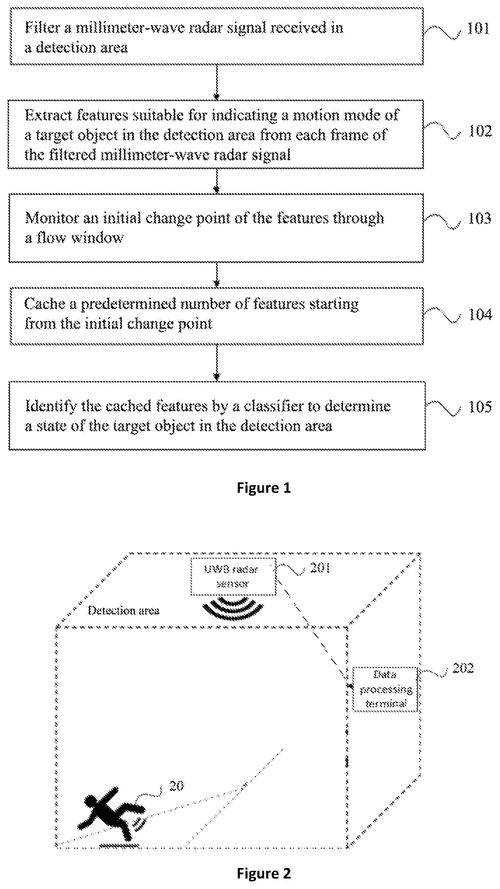

FIG. 1 is a flowchart of a detection method provided in an embodiment of this application. The detection method provided in this embodiment may be performed by a terminal (for example, a mobile terminal such as a notebook computer, a personal computer, etc., or a fixed terminal such as a desktop computer). In an exemplary embodiment, the terminal may be integrated with an Ultra Wideband (UWB) radar sensor and placed in a detection area for state detection. Alternatively, the terminal may be connected wiredly or wirelessly to a UWB radar sensor configured in the detection area.

As shown in FIG. 1, the detection method provided by this embodiment includes the following steps 101-105.

In step 101, a millimeter-wave radar signal received in a detection area is filtered.

In step 102, features suitable for indicating a motion mode of a target object in the detection area are extracted from each frame of the filtered millimeter-wave radar signal.

In step 103, an initial change point of the features is monitored through a flow window.

In step 104, a predetermined number of features starting from the initial change point are cached.

In step 105, the cached features are identified by a classifier to determine a state of the target object in the detection area.

In an exemplary embodiment, a millimeter-wave radar signal may be received by a UWB radar sensor within a detection area. A plane where the UWB radar sensor is configured is parallel to the ground in the detection area, and a vertical distance from the ground is greater than or equal to a preset value. The preset value may be determined according to a maximum vertical distance between a top surface and the ground in the detection area, and the preset value needs to be greater than the maximum height of the target object relative to the ground in the detection area. For example, a UWB radar sensor may be placed on the top surface of the detection area.

The UWB radar sensor may include a transmitter and a receiver, the transmitter may transmit a series of millimeter-wave radar signals to the detection area by a transmitting antenna, and the receiver may receive millimeter-wave radar signals returned from the detection area (for example, a millimeter-wave radar signal reflected from the target object or another obstacle in the detected area). Unlike a traditional RF sensor which uses a narrow-band signal, the UWB radar sensor uses short pulses, resulting in higher resolution, lower power consumption and greater anti-noise capability.

FIG. 2 is a schematic diagram of an exemplary application environment for the detection method provided by an embodiment of this application. In this example, the target object may be a user 20, and the detection area may be a bathroom environment. The detection method in this example may be used to detect whether the user 20 falls in the bathroom. Herein, the UWB radar sensor 201 may be installed on the ceiling of the bathroom. The transmitter of the UWB radar sensor 201 sends a series of millimeter-wave radar signals that propagate in the bathroom, the millimeter-wave radar signals are reflected from obstacles including the user 20, and the reflected millimeter-wave radar signals are received by the receiver. The UWB radar sensor 201 may transmit the received millimeter-wave radar signals into a data processing terminal 202 as input. Steps 101 to 105 are then performed by the data processing terminal 202, to detect the user 20's activities in the bathroom and determine whether the user 20 falls in the bathroom.

In an application example, the UWB radar sensor 201 and the data processing terminal 202 may be configured separately. The data processing terminal 202 may be an intelligent home control terminal (for example, it may be configured in or outside the bathroom), and it may provide users with a human-computer interaction interface. For example, it may provide information prompt or send alarm information etc. on the human-computer interaction interface when detecting that a user falls down. For example, as shown in FIG. 2, the UWB radar sensor 201 may be configured on the ceiling of the bathroom, and the data processing terminal 202 may be configured on the side wall of the bathroom. The UWB radar sensor 201 and the data processing terminal 202 may perform data interchange through a wired or wireless manner. In another application example, the UWB radar sensor 201 and the data processing terminal 202 may be integrated into a device that wirelessly transmits a result of fall detection to a target terminal (for example, the mobile phone of a family member of the user 20).

In this embodiment, a UWB radar sensor is used for contactless remote sensing. Based on a millimeter-wave radar signal, state identification is carried out. The millimeter-wave radar signal has high resolution and high penetrating power, and it can penetrate obstacles and detect very small targets. Moreover, it has a very low power spectral density, thus the millimeter-wave radar signal can be prevented from being interfered by other radio systems in the same frequency range. By using the millimeter-wave radar signal for detection, not only can privacy protection be achieved, but also the detection effect is ensured.

In an exemplary embodiment, step 101 may include, for M frames of the millimeter-wave radar signal Rₖ=[Rₖ(1),Rₖ(2), . . . ,Rₖ(M)] received in the detection area within a set duration, filtering the M frames of the millimeter-wave radar signal according to the following formula:

$${Q}_{k} ( i ) = {R}_{k} ( i ) - \frac{{\sum }_{j = 1}^{M} {R}_{k} ( j )}{M} , i = 1 , 2 , … , M ;$$

$${W}_{k} ( i ) = {Q}_{k} ( i ) - \frac{{\sum }_{j = 1}^{M} {Q}_{k} ( j )}{L} , i = 1 , 2 , … , M ;$$

Where, L represents the total number of frames in which there is no target object in the detection area, that is, the total number of frames in which there are only static obstacles in the detection area, within the set duration; M and L are both integers.

In this exemplary embodiment, when filtering the millimeter-wave radar signal, the noise therein is reduced by calculating Qₖ(i), and the clutter therein is reduced by calculating Wₖ(i), so that the target object may be identified in the detection area.

In an exemplary embodiment, step 102 may include: for each frame of the filtered millimeter-wave radar signal, according to an average distance between multiple scattering centers of the target object and the UWB radar sensor, determining the features suitable for indicating the motion mode of the target object in the detection area; or, according to a distance between a center of gravity of the target object and the UWB radar sensor, determining the features suitable for indicating the motion mode of the target object in the detection area.

In this exemplary embodiment, the motion mode of the target object within the detection area is reflected by feature extraction based on arrival time (FEAT). The FEAT may be determined based on the distance between the target object and the UWB radar sensor. And the change of FEATs of multiple frames of the millimeter-wave radar signal may reflect the change of the distance between the target object and the UWB radar sensor.

When the target object is a human body, because the human body includes multiple scattering centers, such as head, shoulders, torso, legs, etc., the UWB radar sensor may receive millimeter-wave radar signals from multiple paths fed back by the human body. The FEAT of each path depends on the distance between the scattering center of the path and the UWB radar sensor. Because the motion of the target object may result in the motion of the scattering center, when the target object moves, the FEATs of multiple paths corresponding to the target object also change based on the motion of the target object. In this embodiment, the state of the target object in the detection area may be identified by analyzing the change of FEATs.

In an exemplary embodiment, according to the average distance between multiple scattering centers of the target object and the UWB radar sensor, determining the features suitable for indicating the motion mode of the target object in the detection area may include: determining the features suitable for indicating the motion mode of the target object in the detection area according to the following formula:

$${FEAT}_{i} = \frac{2 \cdot {d}_{i}}{c} ;$$

The FEATᵢ is a feature which is extracted from an i^{th} frame of the millimeter-wave radar signal and indicates the motion mode of the target object in the detection area; dᵢ is an average distance between multiple scattering centers of the target object and the UWB radar sensor in the i^{th} frame of the millimeter-wave radar signal; the value of c is the speed of light, for example, it may be the speed of light in a vacuum, 3×10⁸ m/s. However, this is not restricted in the present application. In other implementations, dᵢ may be a distance between the center of gravity of the target object and the UWB radar sensor in the i^{th} frame of the millimeter-wave radar signal. In addition, the value of c may be other reference values, and this is not restricted in the present application.

In this embodiment, FEATs of multiple frames of the millimeter-wave radar signal may be achieved by extracting features of the millimeter-wave radar signal. This group of FEATs may reflect a distance change between the target object and the UWB radar sensor. By extracting FEATs, the features indicating the motion mode of the target object in the millimeter-wave radar signal may be enhanced, and then the state identification may be carried out, thus improving the detection effect.

In this embodiment, by step 102, a FEAT is extracted from each frame of the filtered millimeter-wave radar signal, and a group of FEATs are obtained from multiple frames of the millimeter-wave radar signal. Then by step 103, this group of FEATs are monitored to determine an initial change point in the group of FEATs (for example, a FEAT with a large difference from other FEATs is taken as the initial change point). Then by step 104, a predetermined number of FEATs starting from the initial change point are cached. Then by step 105, the group of cached FEATs are identified by a classifier to determine the state of the target object within the detection area.

In an exemplary embodiment, the classifier may include a random forest classifier. However, this application is not limited to this. In other implementations, other algorithms, such as a decision tree algorithm, etc., may be used to realize classification in this embodiment.

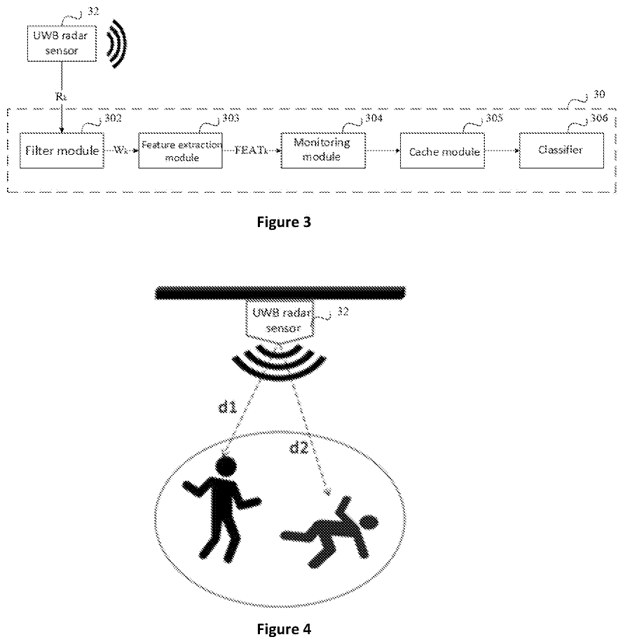

FIG. 3 is a schematic diagram of a detection device provided by an embodiment of this application. The detection device provided by this embodiment is used for detecting a state of a target object in a detection area. As shown in FIG. 3, the detection device 30 provided by this embodiment includes: a filter module 302, a feature extraction module 303, a monitoring module 304, a cache module 305, and a classifier 306.

The filter module 302 is adapted to filter a millimeter-wave radar signal received in the detection area. The feature extraction module 303 is adapted to extract features suitable for indicating a motion mode of the target object in the detection area from each frame of the filtered millimeter-wave radar signal. The monitoring module 303 is adapted to monitor an initial change point of the features through a flow window. The cache module 304 is adapted to cache a predetermined number of features starting from the initial change point. The classifier 306 is adapted to identify the cached features to determine the state of the target object in the detection area.

In an exemplary embodiment, the millimeter-wave radar signal may be received by the UWB radar sensor 32 in the detection area. A plane where the UWB radar sensor 32 is set is parallel to the ground in the detection area, and a vertical distance between the UWB radar sensor 32 and the ground is greater than or equal to a preset value.

In an exemplary embodiment, the feature extraction module 303 may extract the features suitable for indicating the motion mode of the target object in the detection area from each frame of the filtered millimeter-wave radar signal by the following way: for each frame of the filtered millimeter-wave radar signal, according to an average distance between multiple scattering centers of the target object and the UWB radar sensor, determining the features suitable for indicating the motion mode of the target object in the detection area; or, according to a distance between a center of gravity of the target object and the UWB radar sensor, determining the features suitable for indicating the motion mode of the target object in the detection area.

In an exemplary embodiment, the feature extraction module 303 may determine the features suitable for indicating the motion mode of the target object in the detection area according to the average distance between the multiple scattering centers of the target object and the UWB radar sensor by the following way: determining the features suitable for indicating the motion mode of the target object in the detection area according to the following formula:

$${FEAT}_{i} = \frac{2 \cdot {d}_{i}}{c} ;$$

Where, the FEATᵢ is a feature which is extracted from an i^{th} frame of the millimeter-wave radar signal and indicates the motion mode of the target object in the detection area, dᵢ is an average distance between multiple scattering centers of the target object and the UWB radar sensor in the i^{th} frame of the millimeter-wave radar signal, and the value of c is a speed of light.

The relevant description of the detection device provided by this embodiment may refer to the description of the above embodiment of the detection method, so it is not repeated here.

FIG. 4 is a schematic diagram of an application example provided in an embodiment of this application. The application example is illustrated below in conjunction with FIGS. 3 and 4. In this application example, states of the target object in the detection area may include a falling state (such as falling forward, falling backward, falling sideways, etc.) and a non-falling state (such as walking normally, walking randomly, etc.). Herein, detecting whether a user (the target object) falls in the bathroom (detection area) is described as an example.

In this exemplary embodiment, UWB radar sensor 32 may be configured on the ceiling of the bathroom, as shown in FIG. 4. The UWB radar sensor 32 may transmit a millimeter-wave radar signal in the bathroom, and receive a returned millimeter-wave radar signal within the bathroom, and transmit each frame of the millimeter-wave radar signal obtained in real time to a data processing terminal (For example, the detecting device 30 in FIG. 3), so that the data processing terminal detects whether the target object is in a falling state in the bathroom based on the millimeter-wave radar signal received.

In this exemplary embodiment, the data processing terminal may include a filter module, a feature extraction module, a monitoring module, a cache module, and a classifier. For example, the data processing terminal may be a terminal independent of the UWB radar sensor 32. Alternatively, the data processing terminal may be integrated with the UWB radar sensor 32 on a single device, configured on the top surface within the detection area.

In this exemplary embodiment, a millimeter-wave radar signal returned by the K^{th} transmitting pulse within any set continuous duration may be denoted as Rₖ, and Rₖ=[Rₖ(1),Rₖ(2), . . . ,Rₖ(M)] which represents a vector composed of the millimeter-wave radar signal received within the set duration, where M is the total number of frames of the millimeter-wave radar signal received within the set duration, and M is an integer.

After receiving Rₖ, the filter module may conduct data filtering through the following two formulas to reduce noise and clutter in the millimeter-wave radar signal:

$${Q}_{k} ( i ) = {R}_{k} ( i ) - \frac{{\sum }_{j = 1}^{M} {R}_{k} ( j )}{M} , i = 1 , 2 , … , M ;$$

$${W}_{k} ( i ) = {Q}_{k} ( i ) - \frac{{\sum }_{j = 1}^{M} {Q}_{k} ( j )}{L} , i = 1 , 2 , … , M ;$$

Where, L is the total number of frames in which there is no target object in the detection area, that is, the total number of frames in which there are only static obstacles in the detection area, within the set duration; L is an integer.

In this exemplary embodiment, since the UWB radar sensor 32 is configured on the ceiling of the detection area, it can be seen from FIG. 4 that the distance between the target object (user) and the UWB radar sensor 32 may change during the process from walking upright to lying down horizontally of the target object, for example, the distance increases from d₁ to d₂.

In the upper half of FIG. 5, the abscissa represents time, and the ordinate represents the distance between the target object and the UWB radar sensor. The “Pre-fall” represents the time when the target object walks normally; the “Fall” denotes the time from walking upright normally to lying down horizontally of the target object; the “Post-fall” refers to the time after the target object lies down horizontally; and the “Fall clearance” represents the time from lying down horizontally to walking upright normally again of the target object. According to the upper half of FIG. 5, when the target object falls, the distance between the target object and the UWB radar sensor may change greatly, such as increasing from d₁ to d₂, and the falling speed v of the target object may be reflected in this process.

Although the falling process may be reflected by the distance between the target object and the UWB radar sensor, in order to enhance the falling process to improve the detection effect, in this exemplary embodiment, the FEAT of each frame of the millimeter-wave radar signal is extracted for subsequent state identification.

In this exemplary embodiment, the human body as a target object includes multiple scattering centers, such as head, shoulders, torso, legs, etc. The UWB radar sensor may receive millimeter-wave radar signals that are fed back from multiple paths. And the FEAT of each path depends on the distance between the scattering center and the UWB radar sensor. Because the motion of the target object causes the motion of the scattering centers, the FEATs of multiple paths also change based on the motion of the target object when the target object moves.

In this exemplary embodiment, the feature extraction module may extract an average FEATᵢ from each frame of the filtered millimeter-wave radar signal, which is used to simulate the motion mode of the target object. For example, in FIG. 4, FEATs of multiple paths starting from the head of the target object may be obtained according to the following formula:

$${FEAT}_{i} = \frac{2 \cdot {d}_{i}}{c} ;$$

Where, the dᵢ is the average distance between multiple scattering centers of the target object and the UWB radar sensor in the i^{th} frame of the millimeter-wave radar signal, and the value of c is the speed of light, namely 3×10⁸ m/s.

In this exemplary embodiment, the curve diagram shown in the lower half of FIG. 5 may be obtained by performing feature extraction on the filtered millimeter-wave radar signal. Herein, the abscissa is time and the ordinate is FEAT. In the lower half of FIG. 5, the falling speed V_{UWB} of the target object sensed by the UWB radar sensor may be reflected, and the falling speed may be obtained according to the ratio of displacement of the target object in a period of time and the time interval. In this exemplary embodiment, the V_{UWB} may be calculated according to the following formula:

$${V}_{UWB} = \frac{( {FEAT}_{{d}_{1}} - {FEAT}_{{d}_{2}} )}{t} = μ \cdot \frac{\vert {d}_{1} - {d}_{2} \vert}{t} = μ \cdot V ;$$

Where, d₁ and d₂ are distances between the target object and the UWB radar sensor at time point t₁ and time point t₂ respectively; t is a time interval between the time point t₁ and the time point t₂; u is 2/c, and the value of c may be the speed of light, namely 3×10⁸ m/s; and V is the falling speed of the target object.

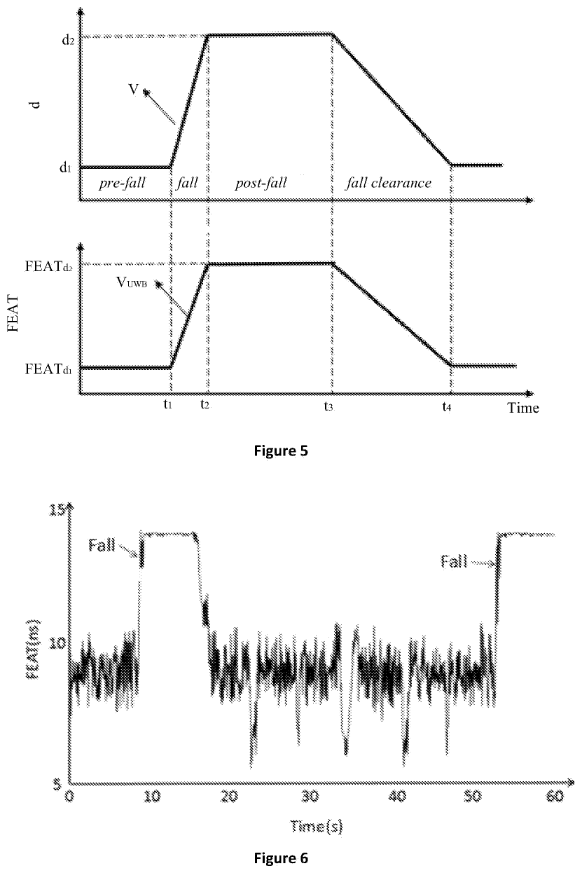

FIG. 6 is a schematic diagram of the FEAT of the target object performing a series of random activities in the bathroom. As shown in FIG. 6, when the target object falls, it can be clearly seen that the FEAT changes significantly. Thus, after FEAT is extracted from the millimeter-wave radar signal, whether the target object falls may be detected by analyzing the change of FEAT, thus improving the detection effect.

In this exemplary embodiment, because each activity of the target object may cause a change in the millimeter-wave radar signal received by the UWB radar sensor, the FEAT extracted from the millimeter-wave radar signal may also change, and subsequently the state of the target object may be identified by detecting the change of FEAT. After the feature extraction module extracts the FEAT from the filtered millimeter-wave radar signal, the monitoring module may monitor an initial change point in a group of FEATs through the flow window. For example, the Z-score and Z-test may be used to detect the initial change point of a group of FEATs extracted from multiple frames of the millimeter-wave radar signal. Herein, the feature extraction module may perform feature extraction on the multiple frames of the filtered millimeter-wave radar signal to obtain a group of FEATs (for example, as shown in FIG. 6). The monitoring module detects whether there is an abnormal change in the group of FEATs through a flow window, and detects an initial change point for the abnormal change (for example, a FEAT that differs greatly from other FEATs), then begins to cache a predetermined number of FEATs starting from the initial change point, so that the classifier may perform classification and identification.

For example, a 10-frame sliding window may be used to detect FEATs extracted from multiple frames of the millimeter-wave radar signal. A sliding step size of the sliding window may be 1 frame. An average FEAT for any sliding window may be calculated. Then, the average FEAT of the sliding window is compared with the total FEAT average for a preset duration. And through the comparison, a FEAT with a large difference is found and taken as the initial change point. Then, a predetermined number of FEATs starting from the initial change point are cached. The predetermined number may be configured according to the actual scenario, for example, the predetermined number may be 400, which corresponds to 400 frames of the millimeter-wave radar signal. However, this is not restricted in the present application. The preset duration may be determined according to the actual scenario, and it may be greater than or equal to the duration of a sliding window.

In this exemplary embodiment, features are cached by the cache module, and then classification and identification are performed, so as to avoid misjudgment of falling. In other words, when the classifier performs classification and identification, analysis may be performed based on FEATs within a certain period of time, and a situation that an elderly cannot stand up after falling may be effectively detected, while for a situation that a young person stands up in time after falling down, an alarm may be avoided, thus avoiding an s unnecessary alarm notification.

In the exemplary embodiment, when the monitoring module does not detect an abnormal change of FEAT, it may be confirmed that any activity of the target object is not detected, that is, state identification by the classifier may be not necessary. Caching and classification and identification are performed only after it is determined that there is an abnormal change in FEAT.

In this exemplary embodiment, a random forest classifier is used as a classifier for identifying falling and non-falling states. The random forest classifier may obtain multiple samples from a sample set by resampling, and then select features of falling for these samples, and obtain an optimal segmentation point by establishing a decision tree. Then, the process is repeated for 200 times to generate 200 decision trees. Finally, a state prediction is carried out through a majority voting mechanism.

In this exemplary embodiment, 200 scenarios are configured to simulate different fall or non-fall scenarios, as shown in table 1, including 120 different fall scenarios and 80 non-fall scenarios in a bathroom. The fall scenarios include the following six common situations in a bathroom: falling forward when walking into the bathroom, falling backwards when walking into the bathroom, falling sideways when walking into the bathroom, falling during a shower, falling when sitting on the toilet, and simulating various faints in the bathroom. The non-fall scenarios include the following four scenarios: walking normally in the bathroom, walking quickly in the bathroom, walking around randomly in the bathroom, squatting or sitting on the floor.

TABLE 1

| | | Behavior |
|---|---|---|
| Behavior | Count | classification |
| Falling forward when walking | 20 | Fall |
| into the bathroom | | |
| Falling backwards when walking | 20 | Fall |
| into the bathroom | | |
| Falling sideways when walking | 20 | Fall |
| into the bathroom | | |
| Falling during a shower | 20 | Fall |
| Falling when sitting on the toilet | 20 | Fall |
| Simulating various faints in the | 20 | Fall |
| bathroom | | |
| Walking normally in the bathroom | 20 | Non-fall |
| Walking quickly in the bathroom | 20 | Non-fall |
| Walking around randomly in the | 20 | Non-fall |
| bathroom | | |
| Squatting or sitting on the floor of | 20 | Non-fall |
| the bathroom | | |

In this exemplary embodiment, the random forest classifier may be trained according to the samples of the scenarios shown in table 1, so as to detect the falling state of the target object in the bathroom in subsequent practical use.

In the exemplary embodiment, UWB radar detection technology is used to detect whether the target object falls indoors, which may bring higher resolution, lower power consumption, and stronger noise resistance. Moreover, the UWB radar sensor is installed on the ceiling of the bathroom, and FEAT may be extracted from the millimeter-wave radar signal to analyze whether the target object falls, thus ensuring the detection effect.

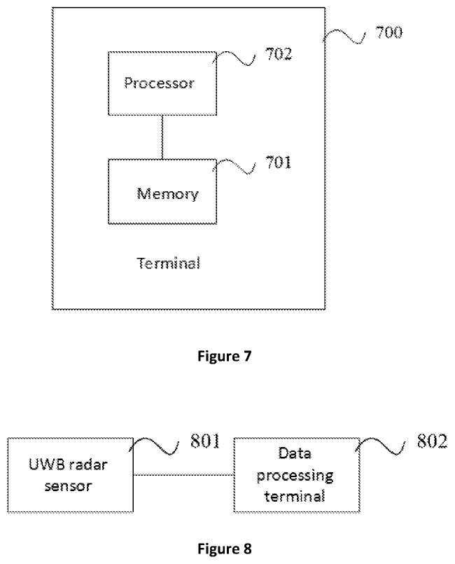

FIG. 7 is a schematic diagram of a terminal provided by an embodiment of this application. An embodiment of this application provides a terminal 700 as shown in FIG. 7, including a memory 701 and a processor 702. The memory 701 is adapted to store a detection program which, when executed by the processor 702, cause the processor 702 to implement steps of the detection method provided by the above embodiment, such as the steps shown in FIG. 1. The skilled in the art could understand that the structure shown in FIG. 7 is only a schematic diagram of part of the structure related to the solution of this this application, but does not constitute a limitation on the terminal 700 on which the solution of this application is applied. The terminal 700 may contain more or fewer parts than shown in the figure, or combine some parts, or have different layouts of parts.

The processor 702 may include, but not limited to, a processing device such as a microprocessor (for example, Microcontroller Unit (MCU)) or a programmable logic device (for example, Field Programmable Gate Array (FPGA)). The memory 701 may be used to store software programs and modules of application software, such as program instructions or modules corresponding to the detection method in this embodiment. The processor 702 implements various functional applications and data processing, such as implementing the fall detection method provided by the embodiment, by running software programs and modules stored in the memory 701. The memory 701 may include a high-speed ram and may also include a non-transitory memory, such as one or more magnetic storage devices, flash memories, or other non-transitory solid-state memories. In some examples, the memory 701 may include a memory configured remotely from the processor 702, the remote memory may be connected to the terminal 700 via a network. An example of the network includes, but not limited to, Internet, Intranet, LAN, mobile communication network, and a combination thereof.

In an exemplary embodiment, the terminal 700 may further include: a UWB radar sensor, a connection processor 702. In this exemplary embodiment, a plane where the terminal 700 is located is parallel to the ground in the detection area and the vertical distance from the ground is greater than or equal to a preset value.

The relevant implementation process of the terminal provided by this embodiment may refer to the description of the above detection method embodiment, so it is not repeated here.

FIG. 8 is a schematic diagram of a detection system provided by an embodiment of this application. As shown in FIG. 8, the detection system provided by this embodiment is used to detect a state of a target object in a detection area, including: a UWB radar sensor 801 and a data processing terminal 802.

The UWB radar sensor 801 is adapted to transmit a millimeter-wave radar signal and receive a returned millimeter-wave radar signal in the detection area. The data processing terminal 802 is adapted to acquire the received millimeter-wave radar signal from the UWB radar sensor 801 and filter the received millimeter-wave radar signal; extract features suitable for indicating a motion mode of the target object in the detection area from each frame of the filtered millimeter-wave radar signal; monitor an initial change point of the features through a flow window, and cache a predetermined number of features starting from the initial change point; identify the cached features by a classifier to determine the state of the target object in the detection area.

In an exemplary embodiment, a plane where the UWB radar sensor 801 is configured is parallel to the ground in the detection area, and the vertical distance from the ground is greater than or equal to a preset value.

In addition, the relevant implementation process of the detection system provided by this embodiment may refer to the relevant description of the above detection method and detection device, so it is not repeated here.

In addition, an embodiment of this application provides a computer readable medium in which a detection program is stored for implementing steps of the detection method provided by the above embodiment, for example, the steps shown in FIG. 1, when the detection program is executed by a processor.

One of ordinary skill in the art could understand that all or some of the steps, systems, and functional modules/units in the methods disclosed above may be implemented as software, firmware, hardware, and their appropriate combinations. In the hardware embodiment, the division between functional modules/units mentioned in the above description does not necessarily correspond to the division of physical components. For is example, a physical component may have multiple functions, or a function or step may be performed by several physical components working together. Some or all components may be implemented as software executed by a processor, such as a digital signal processor or microprocessor; or it is implemented as hardware; or it may be implemented as an integrated circuit, such as an application-specific integrated circuit. Such software may be distributed over computer readable media, which may include computer storage media (or non-temporary media) and communication media (or temporary media). As known to one of ordinary skill in the art, the term, computer storage media, includes transitory, non-transitory, removable, non-removable media implemented in any method or technology used for storing information (such as computer readable instructions, data structures, program modules or other data). Computer storage media include, but not limited to, RAM, ROM, EEPROM, flash memory or other storage technology, CD-ROM, Digital Video Disk (DVD) or other optical disk storage, magnetic box, magnetic tape, disk storage or other magnetic storage device, or any other medium that may be used to store desired information and may be accessed by a computer. In addition, it is well known to one of ordinary skill in the art that the communication media usually contain computer-readable instructions, data structures, program modules, or other data in modulated data signal such as carriers or other transmission mechanisms, and may include any information transmission medium.

Basic principles and main features of this application and advantages of this application are illustrated and described above. This application is not limited to the above embodiments. What is described in the above embodiments and the specification only explains the principle of this application. Without departing from the spirit and scope of this application, there may be various changes and improvements for this application, and these changes and improvements shall fall into the protection scope of the present application.

1. A detection method for detecting a state of a target object in a detection area, comprising:
filtering a millimeter-wave radar signal received in the detection area;
extracting features for indicating a motion mode of the target object in the detection area from each frame of the filtered millimeter-wave radar signal;
monitoring an initial change point of the features through a flow window;
caching a predetermined number of features starting from the initial change point; and
identifying the cached features by a classifier to determine the state of the target object in the detection area.

2. The method of claim 1, wherein the millimeter-wave radar signal is received by an ultra-wideband radar sensor within the detection area, and a plane where the ultra-wideband radar sensor is configured is parallel to the ground in the detection area, and a vertical distance from the ground is greater than or equal to a preset value.

3. The method of claim 2, wherein extracting the features for indicating the motion mode of the target object in the detection area from each frame of the filtered millimeter-wave radar signal, comprises:
for each frame of the filtered millimeter-wave radar signal, according to an average distance between a plurality of scattering centers of the target object and the ultra-wideband radar sensor, determining the features for indicating the motion mode of the target object in the detection area; or, according to a distance between a center of gravity of the target object and the ultra-wideband radar sensor, determining the features for indicating the motion mode of the target object in the detection area.

4. The method of claim 3, wherein according to the average distance between the plurality of scattering centers of the target object and the ultra-wideband radar sensor, determining the features for indicating the motion mode of the target object in the detection area, comprises:
determining the features for indicating the motion mode of the target object in the detection area according to a following formula:
$${FEAT}_{i} = \frac{2 \cdot {d}_{i}}{c} ;$$
wherein the FEATᵢ is a feature which is extracted from an i^{th} frame of the millimeter-wave radar signal and indicates the motion mode of the target object in the detection area; the dᵢ is an average distance between the plurality of scattering centers of the target object and the ultra-wideband radar sensor in the i^{th} frame of the millimeter-wave radar signal; and a value of c is a speed of light.

5. The method of claim 1, wherein filtering the millimeter-wave radar signal received in the detection area comprises:
for M frames of the millimeter-wave radar signal Rₖ=[Rₖ(1),Rₖ(2), . . . ,Rₖ(M)] received in the detection area within a set duration, filtering the M frames of the millimeter-wave radar signal according to a following formula:
$${Q}_{k} ( i ) = {R}_{k} ( i ) - \frac{{\sum }_{j = 1}^{M} {R}_{k} ( j )}{M} , i = 1 , 2 , … , M ;$$
$${W}_{k} ( i ) = {Q}_{k} ( i ) - \frac{{\sum }_{j = 1}^{M} {Q}_{k} ( j )}{L} , i = 1 , 2 , … , M ;$$
wherein, L represents a total number of frames in which there is no target object in the detection area within the set duration; M and L are both integers.

6. The method of claim 1, wherein the classifier comprises a random forest classifier.

7. The method of claim 1, wherein states of the target object in the detection area comprise a falling state and a non-falling state.

8. A detection device for detecting a state of a target object in a detection area, comprising:
a filter module, adapted to filter a millimeter-wave radar signal received in the detection area;
a feature extraction module, adapted to extract features for indicating a motion mode of the target object in the detection area from each frame of the filtered millimeter-wave radar signal;
a monitoring module, adapted to monitor an initial change point of the features through a flow window;
a cache module, adapted to cache a predetermined number of features starting from the initial change point; and
a classifier, adapted to identify the cached features to determine the state of the target object in the detection area.

9. A terminal comprising a memory and a processor, wherein the memory is adapted to store a detection program which, when executed by the processor, cause the processor to implement steps of the detection method of claim 1.

10. The terminal of claim 9, wherein the terminal also comprises: an ultra-wideband radar sensor, connected to the processor; wherein, a plane where the terminal is set is parallel to the is ground in the detection area, and a vertical distance from the ground is greater than or equal to a preset value.

11. A detection system for detecting a state of a target object in a detection area, comprising: an ultra-wideband radar sensor and a data processing terminal;
wherein, the ultra-wideband radar sensor is adapted to transmit a millimeter-wave radar signal and receive a returned millimeter-wave radar signal in the detection area;
the data processing terminal is adapted to acquire the received millimeter-wave radar signal from the ultra-wideband radar sensor, and filter the received millimeter-wave radar signal; and extract features for indicating a motion mode of the target object in the detection area from each frame of the filtered millimeter-wave radar signal; monitor an initial change point of the features through a flow window, and cache a predetermined number of features starting from the initial change point; identify the cached features by a classifier to determine the state of the target object within the detection area.

12. The system of claim 11, wherein a plane where the ultra-wideband radar sensor is configured is parallel to the ground in the detection area, and a vertical distance from the ground is greater than or equal to a preset value.

13. A computer-readable medium in which a detection program is stored for implementing steps of the detection method of claim 1 when the detection program is executed by a processor.
